(19) United States
(12) Patent Application Publication
(10) Pub. No.: US 2008/0265560 A1
(43) Pub. Date: Oct. 30, 2008

(54) Postage stamp with stored information

(76) Inventor: Frances Todd Stewart, Pittsburgh, PA (US)

Correspondence Address: Andrew J. Cornelius;Andrew J. Cornelius, P.C., Suite 205, 305 Mt. Lebanon Boulevard, Pittsburgh, PA, 15234, US

(21) Appl. No.: 12/150,116

(22) Filed: Apr. 24, 2008

Related U.S. Application Data
(60) Provisional application No. 60/926,484, filed on Apr. 27, 2007.

(51) Int. Cl. G09F 3/00

(52) U.S. Cl. 283/71

(57) ABSTRACT

A postage stamp includes digital information that can be played by the recipient of the letter or parcel bearing the stamp. The information can be digital in format and can be pictures, audio and/or a video presentation that the country issuing the stamp wishes to disseminate.

### CROSS REFERENCE TO RELATED APPLICATIONS

This application claims the benefit of copending U.S. Provisional Application Ser. No. 60/926,484, filed Apr. 27, 2007, by the same inventor, the entire content of which is hereby incorporated by reference herein.

### BACKGROUND OF THE INVENTION

The present invention relates to postage stamps, and, more particularly, to a postage stamp on which displayable digital information is stored.

Typically, the postal service that is operated by a country's government is responsible for transporting mail to, from and within the country. Typically, a postal service maintains post offices that handle the transport of the mail. Also typically, the postal service imposes a charge or fee on the sender for handling the mail. For each piece of mail that the sender wishes to send, the sender must pay a postal fee in advance of depositing the mail with the postal service. Each piece of mail must bear proof that the postal fee has been paid. Otherwise, the mail is returned to the sender, rather than delivered to the intended recipient. A postage stamp, which is almost always made of paper, is an official government instrument that constitutes one form of proof that the postal fee has been paid. An adhesive is typically provided on the stamp by which the stamp can be affixed to a piece of mail. When stamps are purchased from the postal service, the payor is given one or more stamps bearing a currency value that equals the amount paid. One or more stamps bearing in the aggregate the total postal fee for mailing the piece of mail is affixed to it using the supplied adhesive, and the piece is deposited with the postal service. After ascertaining that stamps bearing the correct postal fee are affixed to the piece of mail, the postal service delivers it, in theory, to the intended recipient.

Thus, most conventional postage stamps are, physically, nothing more than a piece of paper bearing a currency value and country of issue that is affixed to a piece of mail using adhesive provided on the stamp.

### SUMMARY OF THE INVENTION

The present invention is a postage stamp that includes stored digital information that can be displayed. Accordingly, the present invention provides a digital dimension to postage stamps. Thus, the stamp provides the function of a conventional postage stamp in the transport of mail. However, the stamp also can be used to display the digital information to convey a message that is important to the country issuing the stamp. For example, some governments will find the invention to be an important vehicle for enriching an understanding of their country by telling a story related to their country.

Preferably, the stamp is in the form of, or includes, an information storage medium. The storage medium can be any suitable digital storage medium like a computer disc, CD-ROM or DVD's, and, typically, a mini CD-ROM or DVD, on which the information is recorded. The stamp can include both video and still photographs that can be viewed, as well as audio that can be played. Though CD-ROM and DVD's are common in the market, they have not been used as postage. The stamp is labeled with postal information, like the currency value of the stamp and the country that issued the stamp, to enable it to fulfill its function as a postage stamp.

The stamp can be physically configured in any way that will allow it to be affixed or mounted to a piece of mail and allow the postal service of the issuing country to determine whether the stamp shows that the correct postal fee has been paid. Various configurations can be designed to be used as postage stamps on various sizes and shapes of packages and letters. For example, in two of the preferred embodiments of the invention, the stamp includes an envelope for housing the storage medium. Adhesive on the back of the envelope allows the envelope and storage medium to be affixed to a piece of mail.

In an alternate embodiment, the stamp includes a backing card bearing an adhesive on both its sides. One side of the backing card contains a snap friction mount into which the storage medium interlocks. On the backside of the backing card a double stick adhesive is attached. The adhesive on the remaining side of the backing card can be covered with a sheet that can be peeled away to expose the adhesive. The side of the card bearing the exposed adhesive can be pressed against the piece of mail to mount the card, and storage medium, to the piece of mail, and the combination of the two creates the stamp.

In another embodiment, the storage medium is affixed with adhesive directly onto a piece of mail as long as the adhesive is removable and will not affect the playability of the storage medium.

In another embodiment of the invention, the storage medium is encased within a pocket formed on the inside of a standard mailing envelope. With this embodiment, the envelope serves both as a component of the stamp, and the carrier for the piece of mail. Thus, this embodiment provides the sender with an envelope that is pre-stamped.

Preferably, the adhesive by which the stamp is affixed to a piece of mail is on a card attached to the storage medium, on the storage medium itself, or on the back of an envelope into which the storage medium has been placed.

The storage medium can be any type of medium in which information can be stored for playing back at a later time. Preferably, the information is in digital form. The storage medium can be a CD-ROM or DVD made out of any material currently employed for that purpose. The stamp can be affixed to a piece of mail in a variety of ways. Preferably, the stamp is attached to a piece of mail using adhesive.

The postage stamp provided by the present invention bears postal information. Like a conventional paper stamp, the present invention can bear different denominations of a country's currency and the issuing country's name. The information borne by the storage medium of the stamp can be played on a computer or other device that can play the information contained on the stamp. If desired, the stamp can bear visually perceptible graphics or pictures that relate to the digital information on the storage medium.

The digital information stored on the storage medium can be any information that the country issuing the stamp wants to disseminate. The information can be in the form of still photographs or videos, and can also include audio. For example, the information stored on the storage medium can be a video crafted to enrich the understanding of the issuing country of those who receive the stamp on mailed items.

### BRIEF DESCRIPTION OF THE DRAWINGS

The following detailed description of the preferred embodiment may be understood better if reference is made to the appended drawing, in which:

FIG. 1 is a front perspective view of an embodiment of the present invention, showing a stamp in which the storage medium is a mini CD-ROM or DVD that is housed in a plastic envelope inside a paper envelope;

FIG. 2 is a rear perspective view of the stamp shown in FIG. 1;

FIG. 3 is an exploded, perspective view of the stamp shown in FIG. 1;

FIG. 4A and 4B show the paper envelope of the stamp shown in FIG. 1, in its unfolded, pre-assembly state;

FIG. 4C is a perspective view of the plastic envelope of the stamp shown in FIG. 1;

FIG. 4D is a an exploded view of the plastic envelope of the stamp shown in FIG. 1;

FIG. 5A is a top perspective view of another embodiment of the present invention, showing a stamp in which the storage medium is a CD-ROM or a DVD that is housed in an envelope;

FIG. 5B is a bottom perspective view of the stamp shown if FIG. 5A;

FIG. 5C is a top plan view of the stamp shown in FIG. 5A, in which the envelope is in its pre-assembled state, and in which the inside of the envelope is shown;

FIG. 5D is a bottom plan view of the embodiment shown in FIG. 5A, in which the envelope is in its pre-assembled state, and in which the outside of the envelope is shown;

FIG. 5E is a cross-sectional view of the embodiment shown in FIG. 5A, taken along the line 5E-5E;

FIG. 6A is a top plan view of another embodiment of the present invention, in which the storage medium is a CD-ROM or a DVD that is adhered to an adhesive backing card;

FIG. 6B is a bottom plan view of the embodiment shown in FIG. 6A, with the adhesive backing applied;

FIG. 6C is a top plan view of the embodiment shown in FIG. 6A, absent the CD-ROM or DVD;

FIG. 6D is a side sectional view of the stamp shown in FIG. 7A, taken along the line 6D-6D;

FIG. 7A is a rear elevation view of another embodiment of the present invention, in which the storage medium is a CD-ROM or a DVD that is housed in a pocket formed within a mailing envelope, with part of the envelope removed to show the pocket;

FIG. 7B is a side elevation view of the pocket shown in FIG. 7A, with a CD or DVD-ROM sealed within the pocket;

FIG. 7C is a front elevation view of the mailing envelope shown in FIG. 8, and

FIG. 8 is a front elevation view of another embodiment of the present invention in which the storage medium is a CD-ROM or a DVD that includes adhesive for adhering the CD-ROM or DVD to a letter or parcel;

### DETAILED DESCRIPTION OF THE PREFERRED EMBODIMENTS

The attached drawing shows several embodiments of the present invention. The appended claims encompass subject matter not specifically shown in the drawing. For example, while a conventional CD-ROM or DVD, or a mini CD-ROM or DVD, functions well as the digital storage medium, the storage medium can take any form that both allows digital information to be stored on the medium, and played back by a user, while allowing the invention to function as a postage stamp. Similarly, the manner of affixing the stamp to or incorporating the stamp into a piece of mail can take any form, so long as the postal information (for example, currency denomination and issuing country) remains visible during the mailing and delivery process. The invention can vary in size, shape, material and configuration, so long as it can function as a postage stamp. The information stored on the stamp can be digital information. For example, the stored information can be digital video content, still pictures, audio content, or audiovisual content. Typically, for example, the information will be audiovisual content that is stored on the storage medium by the issuing country before it is purchased as a postage stamp by the sender of a piece of mail. For example, the issuing country can store a video on the stamp containing both audio and video that tells a story about the issuing country that the government of the issuing country wishes to disseminate. The components of the stamps shown in the drawing can be constructed from a wide variety of materials. For example, the envelopes shown in the drawing can be made from paper, plastic, or a combination of both.

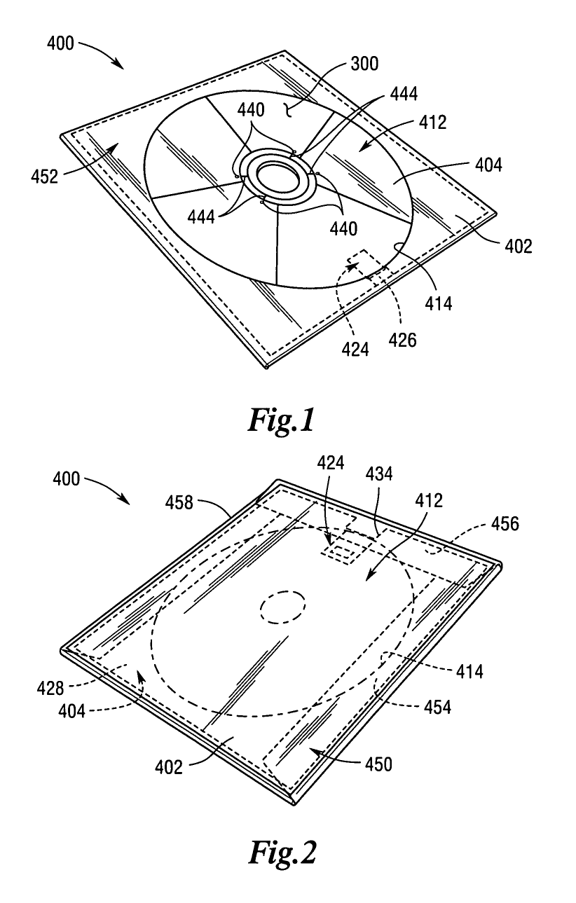

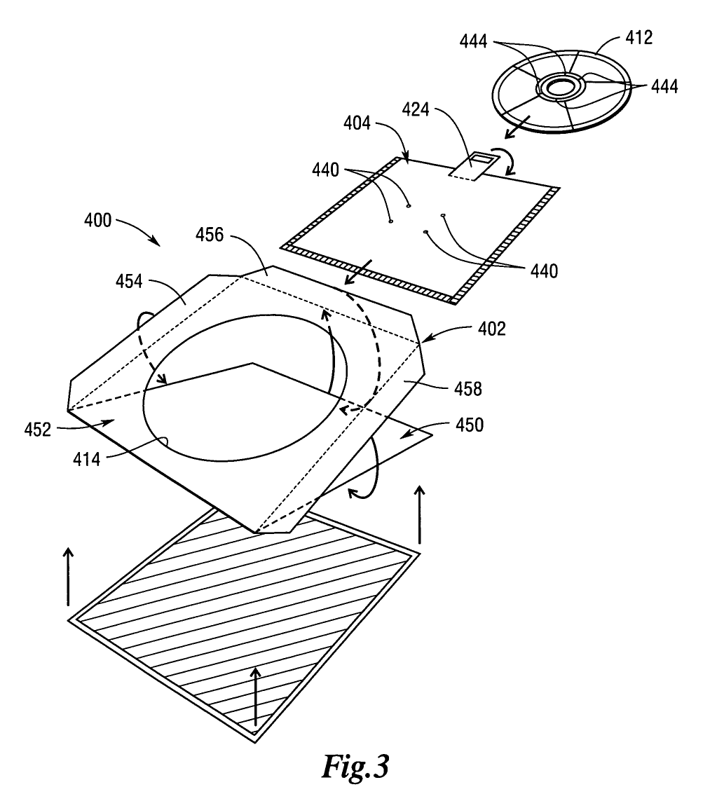

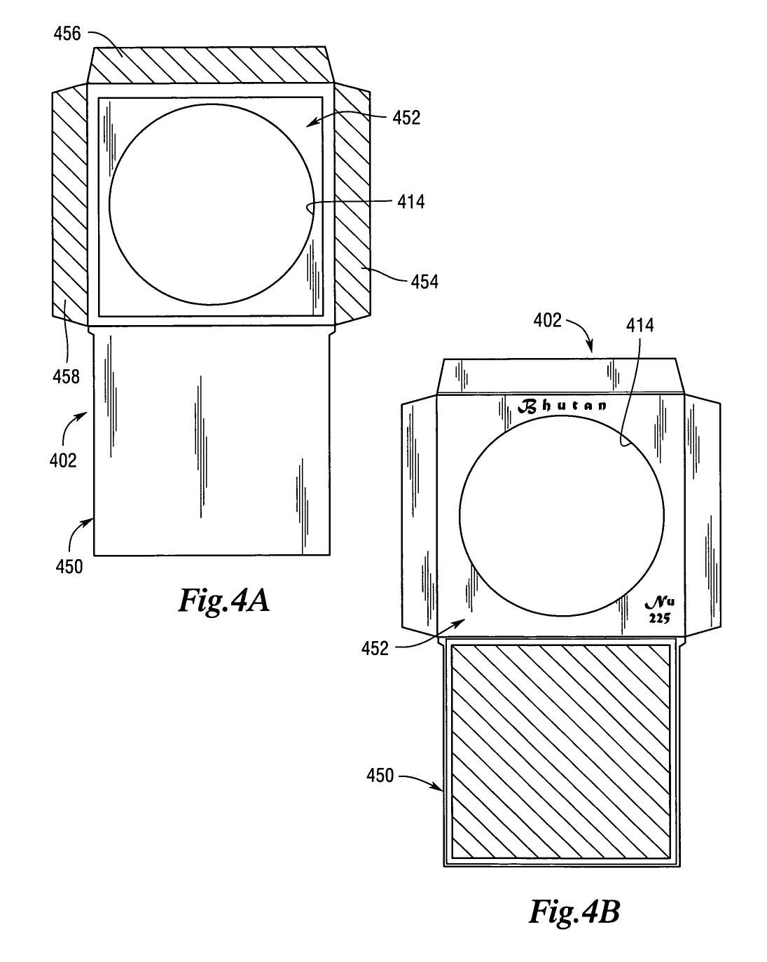

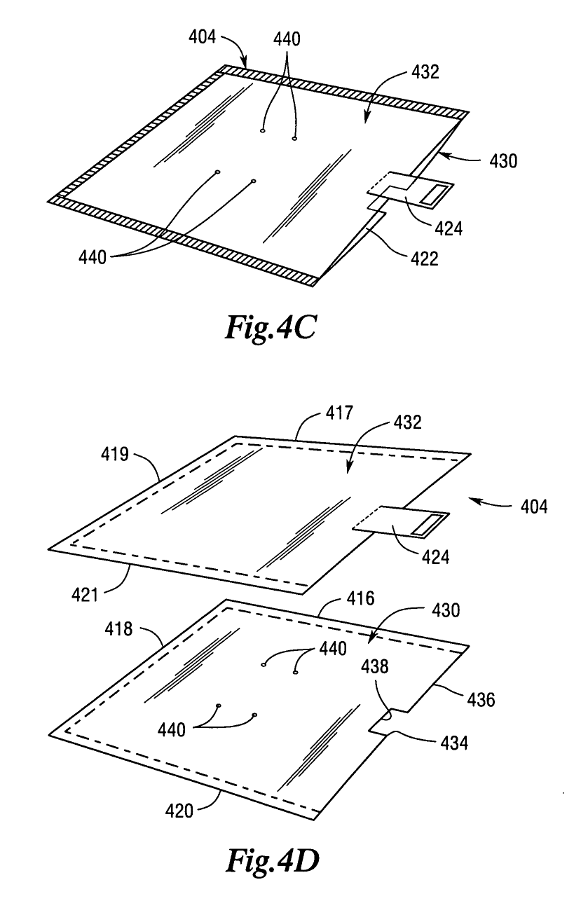

FIGS. 1 through 4 show a postage stamp 400 that can be constructed in accordance with the teachings of the present invention, in which the storage medium 412 is a mini CD-ROM or DVD that is housed in a plastic envelope 404 inside an envelope 402. Postage stamp 400 fixes the position of medium 412 within envelope 402 and with respect to viewing window 414 of envelope 402 using plastic envelope 404, rather than a mounting disc or other device mounted on envelope 402.

Envelope 402 can be identical to envelope 14 of stamp 10, with the exception that envelope 402 does not include mounting disc 16. Instead, stamp 400 employs a plastic envelope 404 to fix the position and orientation of medium 412 with respect to window 414 using orientation guides 440. Envelope 402 defines two panels 450 and 452. Panel 452 defines window 414. Panel 452 also defines three closing flaps 454, 456 and 458, which, as with envelope 14, are used to seal envelope 402 in its closed position around a plastic envelope 404.

Plastic envelope 404 is formed from a pair of plastic panels 430 and 432 that are heat sealed to each other at edges 416, 418 and 420 of panel 430 and 417, 419 and 421 of panel 432 to form a pocket for medium 412, and an opening 422 through which medium 412 can be inserted into envelope 404 between panels 430 and 432. Panel 432 defines a closing flap 424 the can be folded over opening 422 to close envelope 404 and position medium 412 in window opening 414. Side 426 of flap 424 bears an adhesive that adheres flap 424 to side 428 of panel 430 of envelope 404 when flap 424 is pressed against side 428. Preferably, the adhesive is of any type that allows flap 424 to be removably adhered to side 428 by a sender, but removed from side 428 by the recipient to permit the recipient to easily remove medium 412 from within envelope 404. Panel 430 also forms a notch 434 into which flap 424 is inserted as it is folded over edge 436 of panel 430 to secure flap 424 to side 428. Flap 424 is adhered to side 428 in such a manner that a part of flap 424 bears against the bottom 438 of notch 434. This combination of bottom 438 and flap 424 operates to prevent a medium 412 that has been inserted into envelope 404 from moving to any significant extent toward opening 422 and positions medium 412 in window 414. Thus, heat sealed edges 416, 418 and 420 cooperate with flap 424 to fix the position of medium 412 within window 414 of envelope 404.

Stamp 400 includes a registration feature that can be used to properly and visibly ensure that the graphics, including postal information, applied to medium 412 can be viewed through window 414 in the desired orientation. Four registration buttons 440 are formed on inside surface 442 of panel 430. Buttons 440 form the corners of an imaginary rectangle, and are used to orient medium 412 properly within envelope 404. To that end, medium 412 bears four registration markings 444 proximate central opening 446 of medium 412. Registration marks 444 can be aligned with buttons 440 as medium 412 is inserted into envelope 404. When buttons 440 are aligned with marks 444, medium 412 is oriented properly within envelope 404.

Heat sealed edges 416, 418 and 420 cooperate with flap 424 to ensure that movement of medium 412 is limited sufficiently to permit full and constant viewing of all desired graphics on medium 412 through window 414.

In use, a medium 412, on which the desired digital information has been stored, is inserted into envelope 404 through opening 422 and registration buttons 440 are aligned with registration marks 444 on medium 412. Flap 424 is pulled over bottom 438 of notch 434 and secured to side 428 in such a manner that flap 424 bears against bottom 438. Sealed envelope 404 is inserted completely between panels 450 and 452, edge 418 first, and flaps 454, 456 and 458 are used to adhere panels 450 and 452 together around envelope 404 and medium 412. Stamp 400 is then adhered to a letter or package in the same fashion as stamp 10. The recipient of stamp 400 opens envelope 402 in the same manner as envelope 14, and removes envelope 404. The recipient removes tab 424 from side 428 of panel 430, removes medium 412 from within envelope 404, and plays the content on medium 412.

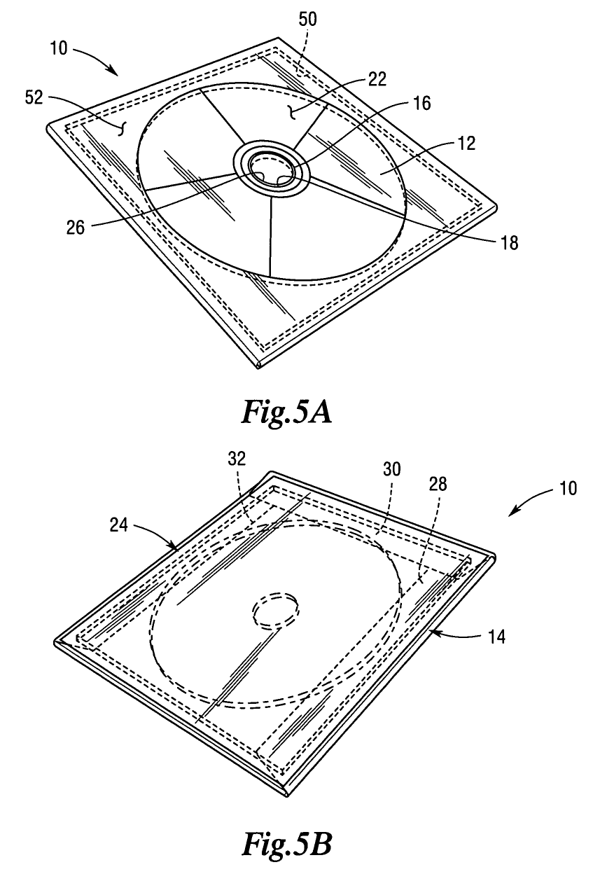

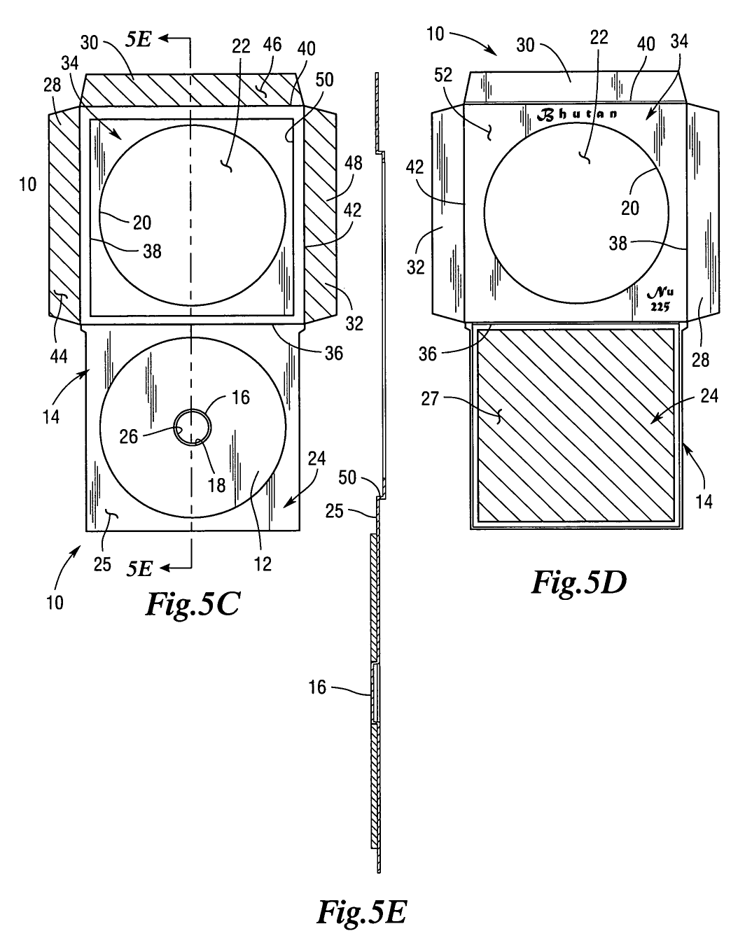

FIGS. 5A, 5B, 5C, 5D and 5E show a postage stamp 10 that can be constructed in accordance with the teachings of the present invention, in which the storage medium 12 is a CD-ROM or a DVD that is housed in an envelope 14. Envelope 14 can be made of paper, plastic or a combination of both materials. Envelope 14 defines a pair of sides 24 and 34, joined to each other at a fold 36. Sections 24 and 34 can be folded toward and away from each other at fold 36 to close and open envelope 14. Side 34 defines an offset 50 in which medium 12 is seated when it is contained within a closed envelope 14. Envelope 14 defines a window 20 that may be covered with clear plastic 22 through which a medium 12 contained within a closed envelope 14 can be viewed. Surface 27 of side 24 bears an adhesive to allow side 24, and envelope 14, to be adhered to a piece of mail. A protective sheet (not shown) may be removably adhered to side 27 to prevent the inadvertent adherence of stamp 10 to an object.

Envelope 14 also defines flaps 28, 30 and 32. Flaps 28, 30 and 32 are joined to side 34 at folds 38, 40 and 42, respectively. Sides 44, 46 and 48 of flaps 28, 30 and 32, respectively, which may also carry an adhesive. Flaps 28, 30 and 32 are used to seal envelope 14 in its closed position.

A central mounting disc 16 is incorporated into envelope 14 by mounting disc 16 to surface 25 of envelope 14 in any suitable fashion. Disc 16 can be of the standard type of ring that is commonly used to mount CD's or DVD's to the inside of a case. Disc 16 is made of a flexible material, like foam or flexible plastic. Consistent with common usage of disc 16, disc 16 is slightly larger than central opening 18 defined by medium 12. As is well known, because disc 16 is flexible, it can be forced into opening 18 of medium 12 to mount medium 12 to panel 24 of envelope 14 by forcing disc 16 into opening 18 until the edges 26 defining opening 18 compress disc 16 sufficiently to allow disc 16 to be pushed into opening 18. When disc 16 is forced into opening 18 and against surface 24, edges 24 allow disc 16 to expand slightly, at which point edges 24 have captured disc 16. Medium 12 can be removed from envelope 14 by forcing medium 12 away from side 24 until edges 26 compress disc 16 sufficiently to allow disc 16 to be removed from within opening 18. The postal information should be applied to surface 52 of panel 34 to ensure that it can be viewed during the mailing and delivery of the piece of mail to which stamp 10 is adhered.

Assembly of postage stamp 10 begins with the mounting onto disc 16 of a medium 12 on which the desired digital information has been recorded. After medium 12 is mounted onto disc 16, sides 24 and 34 of envelope 14 are folded toward each other at fold 36 until sides 24 and 34 touch each other and medium 12 is contained within offset 50. Then, adhesive sides 44, 46 and 48 of flaps 28, 30 and 32, respectively, are folded at folds 38, 40 and 42, respectively, toward surface 27 of side 24 until they contact surface 27. Flaps are squeezed against surface 27 to adhere flaps 28, 30 and 32 to side 24. Finally, adhesive side 27 is pressed against a letter or parcel to adhere stamp 10 thereto. Once the letter or parcel is delivered, medium 12 can be removed from envelope 14 in any suitable fashion to allow the digital information borne by medium 12 to be played. Disc 16 ensures that movement of medium 12 is limited sufficiently to permit viewing of all desired graphics on medium 12 through window 20.

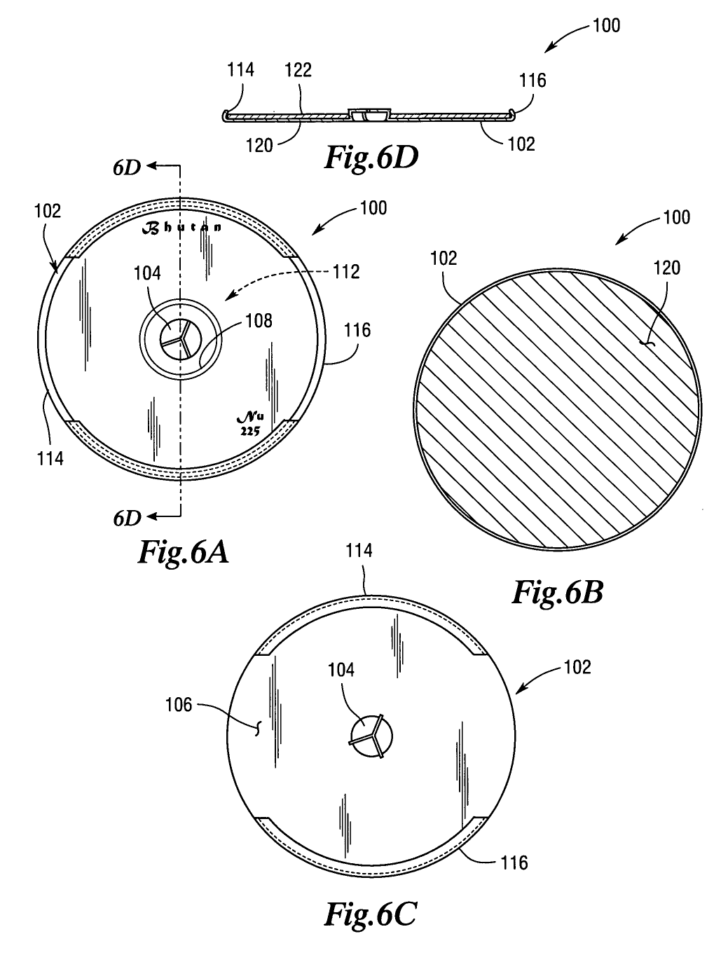

FIGS. 6A, 6B, 6C and 6D show a postage stamp 100 that can be constructed in accordance with the teachings of the present invention, in which the storage medium 112 is a CD-ROM or a DVD that is adhered to an adhesive circular backer card 102 that can be made of any suitable material, including paper, plastic, or a combination of paper and plastic. Backer card 102 is, preferably, about the same size or slightly larger than medium 112 to accommodate the mounting of medium 112 to backer card 102. Alternately, backer card 102 can be of a larger size to allow more room for displaying artwork or information on stamp 100 in addition to the minimum postal information that must be borne by a postage stamp. A conventional split button closure 104 is mounted to surface 106 of backer card 102. Split button closure 104 is a well-known device found in DVD and CD cases for releasably mounting a CD or DVD to the case. Split button 104 fits within central opening 108 defined by medium 112. As is well known, split button 104 can be squeezed together to compress button 104 and to insert button 104 into central opening 108. Button 104 can then be released to allow button 104 to expand and capture medium 112. To remove medium 112 from backer card 102, button 104 is squeezed together to compress button 104 and allow medium 112 to be disengaged from button 104 to remove medium 112 from backer card 102. Alternately, medium 112 can be manipulated until it is forced from button 104.

Backer card 102 defines a pair of curved retainers 114 and 116 that help retain medium 112 in place until a user wishes to remove medium 112 from backer card 102. Retainers 114 and 116 curve over the edge of medium 112 when medium 112 is mounted on backer card 102. Side 120 of backer card 102 bears an adhesive for adhering backer card 102 to a letter or parcel. Postal information may be applied to surface 122 of medium 112, which is visible after stamp 100 is adhered to a letter or parcel. A protective sheet (not shown) may be removably adhered to adhesive side 120 to prevent inadvertent adherence of stamp 100 to a surface.

In use, a medium 112, on which the desired digital information has been stored, is mounted to backer card 102 by forcing button 104 into central opening 108 of medium 112 until medium 112 is engaged with button 104. The protective sheet, if any, is removed from adhesive side 120 of backer card 102, and adhesive side 120 is adhered to a letter or parcel to adhere stamp 100 thereto. Upon receipt of the letter or parcel, the receiver may remove medium 112 from backer card 102 in any conventional manner in which a conventional CD or DVD is disengaged from its case. The information stored on medium 112 can then be played in any suitable fashion.

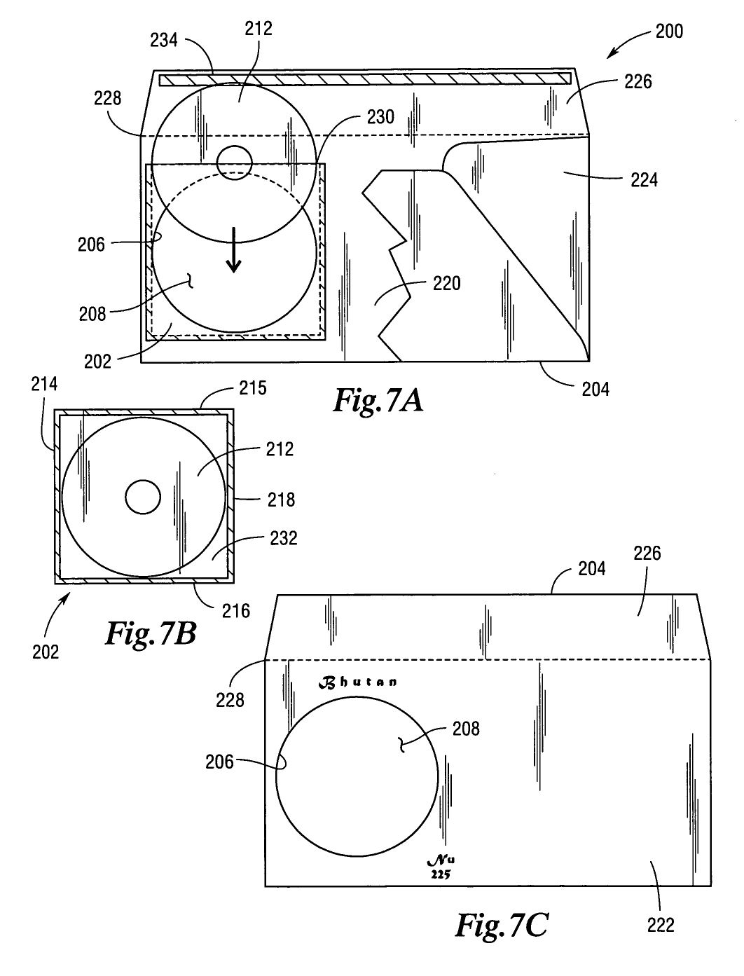

FIGS. 7A, 7B and 7C show a postage stamp 200 that can be constructed in accordance with the teachings of the present invention, in which the storage medium 212 is a CD-ROM or a DVD that is housed in a plastic pocket 202 formed inside a mailing envelope 204. Envelope 204 includes a front panel 222 and a rear panel 224. Front panel 222 defines a closing flap 226 having an edge 234 that bears an adhesive. Flap 226 can be folded at fold 228 to seal envelope 204. Mailing envelope 204 also defines a clear window 206 through which medium 112 can be viewed. Window 206 may be covered with clear plastic 208. Plastic pocket 202 is formed by adhering three edges 214, 216 and 218 of a sheet of plastic 232 together and securing formed pocket 202 onto inside surface 220 of envelope 204. Thus, pocket 202 defines an opening 230 into which medium 212 can be inserted into pocket 202. After insertion of medium 212 into pocket 202, end edges 215 (only one shown) of plastic sheet 232 together to seal medium 212 within pocket 202. The size of pocket 202 ensures that movement of medium 212 is limited sufficiently to permit viewing of all desired graphics on medium 212 through window 206.

In use, stamp 200 is assembled by inserting a medium 212, on which the desired digital information has been stored, into pocket 202 through opening 230. Opening 230 is then sealed by heat sealing to each other end edges 215 of plastic sheet 232. The sender purchases stamp 200, and the documents or letters that are to be mailed are then inserted into envelope 204. Flap 226 is folded at fold 228 toward panel 224 until flap 226 contacts panel 224. Adhesive edge 234 of flap 226 is pressed against panel 222 to seal envelope 204. Address information for the recipient of the letter can be applied to panel 222. Therefore, stamp 200 functions as the stamped mailer of the documents or letters.

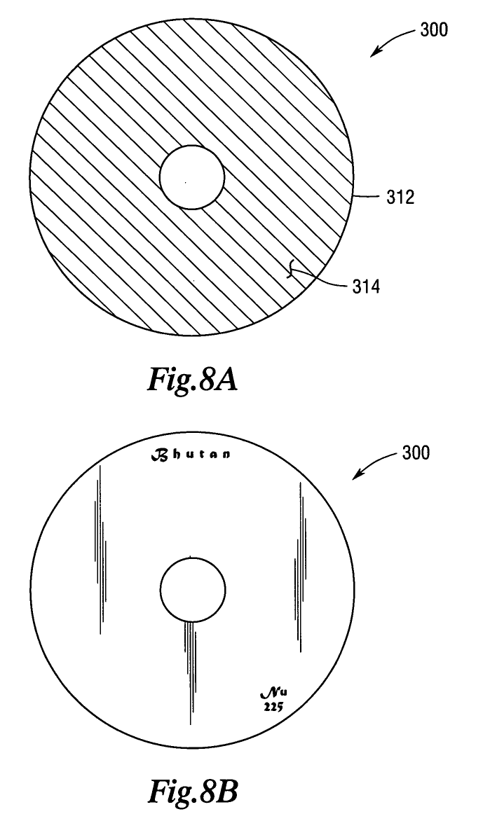

FIG. 8 shows a postage stamp 300 that can be constructed in accordance with the teachings of the present invention, in which the storage medium 312 is a CD-ROM or a DVD that bears an adhesive on one side. An adhesive is applied to surface 314 of medium 312 that is used to adhere stamp 300 to a letter or parcel. The adhesive should be of the type that is removable from the surface of medium 312, and that will not negatively affect the playability of the digital information contained on medium 312. A removable protective sheet (not shown) may be applied to adhesive surface 314 of medium 312 to prevent the inadvertent adherence of medium 312 to a surface. Postal information may be applied to surface 316 of medium 312, which is visible after stamp 300 is adhered to a letter or parcel.

What is claimed is:

1. A postage stamp comprising:
a medium on which digital information is stored and from which said information can be played;
postal information applied to said stamp; and
an adhesive for applying said stamp to an item to be mailed.

2. The postage stamp recited by claim 1 wherein said digital information is audiovisual information.

3. The postage stamp recited by claim 2 wherein said audiovisual information is a video presentation.

4. The postage stamp recited by claim 1 wherein said digital information is a still photograph.

5. The postage stamp recited by claim 1 wherein said digital information is audio information.

6. The postage stamp recited by claim 1 wherein said medium is a compact disc, or CD.

7. The postage stamp recited by claim 1 wherein said medium is a digital video disc, or DVD.

8. The postage stamp recited by claim 1 wherein said medium is housed in an envelope that bears an adhesive used to apply said envelope to an item to be mailed, said postal information being visible when said medium is housed within said envelope.

9. The postage stamp recited by claim 8 wherein said envelope can contain the items to be mailed.

10. The postage stamp recited by claim 1 wherein said stamp includes a backer card to which said medium may be removably mounted, and said adhesive is applied to said backer card so that said stamp can be adhered to the item to be mailed.
